(19) United States
(12) Patent Application Publication
(10) Pub. No.: US 2020/0234267 A1
(43) Pub. Date: Jul. 23, 2020

(54) Encrypted Transaction Receipts

(71) Applicant: Hewlett-Packard Development Company, L.P., Spring, TX (US)

(72) Inventors: Aaron Sanders, Spring, TX (US); Scott Gregory, Spring, TX (US)

(73) Assignee: Hewlett-Packard Development Company, L.P., Spring, TX (US)

(21) Appl. No.: 16/645,999

(22) PCT Filed: Oct. 9, 2017
(86) PCT No.: PCT/US2017/055758

§ 371 Date: Mar. 10, 2020

(51) Int. Cl. G06Q 20/20; G06Q 20/04; G06Q 20/38; G06Q 20/32

(52) U.S. Cl. CPC G06Q 20/209; G06Q 20/3276; G06Q 20/38215; G06Q 20/0453

(57) ABSTRACT

Examples disclosed herein relate encrypted transaction receipts. An example device includes a transaction information cache to store unencrypted transaction information from a vendor. The device may include an encrypter that converts the transaction information into an encrypted receipt based on a first vendor key of an asymmetric key pair and a customer passcode, wherein the encrypted receipt decodes to plain text of the unencrypted transaction information with a second vendor key of the asymmetric key pair and the customer passcode. The device may include an encrypted receipt transmitter to transfer the encrypted receipt.

### BACKGROUND

When purchasing products or services, receipts can be printed to serve as a record of the transaction. The receipt can be printed or sent to a customer digitally. A customer may use a receipt for bookkeeping of expenses, or for returning an item a customer no longer wants or is defective. The transaction information may be written in plain text and printed physically, or sent digitally to an email address or online account of the customer. In an example, an online log of a customer's transaction information can be associated with a customer account and stored by the vendor or payment processor. The online log may not be accessible without logging in to the user account with an appropriate username and password.

### DESCRIPTION OF THE DRAWINGS

Certain examples are described in the following detailed description and in reference to the drawings, in which:

FIG. 1 is a diagram of an example encrypted receipt system including a device for generating encrypted transaction receipts;

FIG. 2A is a schematic diagram showing an encrypted receipt being printed;

FIG. 2B is a schematic diagram showing an encrypted receipt being decrypted;

FIG. 3A is a schematic diagram showing an encrypted receipt being digitally composed;

FIG. 3B is a schematic diagram showing an encrypted receipt being digitally decrypted;

FIG. 4 is a block diagram of an example system for encrypted transaction receipts;

FIG. 5 is a flowchart of an example method for encrypting transaction receipts; and

FIG. 6 is a block diagram of an example non-transitory, computer-readable medium including instructions to direct a processor to encrypt transaction receipts.

### DETAILED DESCRIPTION

The present disclosure relates to generating encrypted receipts. The information on purchases is often written in plain text and may reveal private information about the customer. For example, a customer may wish to keep private information on the receipts of purchases made in a medical context or created when shopping for a surprise gift. Unless encrypted, receipts can reveal what was purchased, cost, and other information as no security or privacy features are built in to receipts.

In the present disclosure, receipt information is encrypted and then transformed and stored in a form that is not readable as plain text. For example the transaction information may be encrypted and then transformed into a visible symbol to be printed on paper as an encrypted receipt. The visible symbol, such as a barcode, can be read by a read by a symbol reader and decoded when a customer would like to again view their transaction information in plain text.

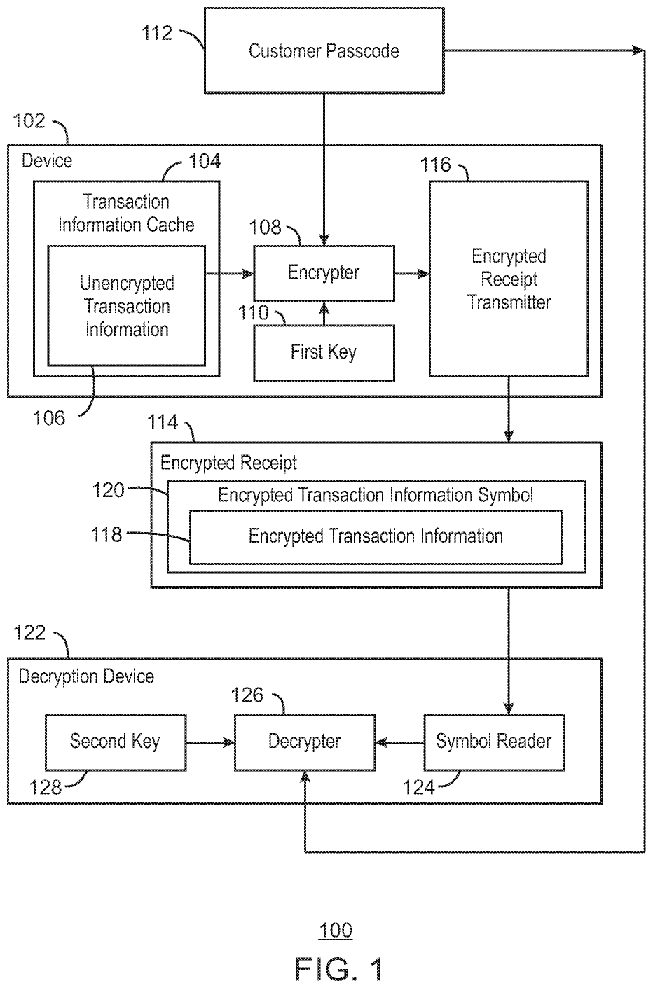

FIG. 1 is a diagram of an example encrypted receipt system 100 including a device 102 for generating encrypted transaction receipts. Directional arrows located in this figure and other figures indicate a general flow of information but are not intended to be limiting with regards to which component may be performing an action such as a push or a pull of information from another component unless otherwise specified.

The device 102 can be a computing device, an add-on component to a current receipt system, or a collection of dispersed components acting in concert as a virtual machine while interfacing with a receipt producing system. The device 102 may include a transaction information cache 104 to store the transaction information. A transaction information cache may be a location in memory or storage hardware or located in a cloud.

Transaction information is information that commonly appears on a receipt including, for example, purchased items, cost of times, date of purchase, time of purchase, location of purchase, sales person who completed the sale, terms of the sale, return policy of each item in the sale, quantity of each item bought, savings applied, tax applied, categorization of tax, payment method, payment amount tendered, loyalty points accrued, amount of tip or gratuity applied, and other related information. At the time of each transaction, the transaction information may be at least temporarily stored in the transaction information cache 104. When first received, the transaction information may be in an unencrypted and readable format, such as plain text, and cached in the transaction information cache 104.

The device 102 includes an encrypter 108 that can encrypt the unencrypted transaction information 106 using a first key 110 and a customer passcode 112. The encrypter 108 may use, in part, an asymmetric cryptographic method where a public key and private key are generated as a key pair. The key pair can be generated from a large random number fed into key generation algorithms that may be based on a mathematical problem that currently admits no efficient solution. The first key and second key of the key pair may also each be composited or mapped with the customer passcode to generate a first hashed key and a second hashed key, respectively. The encrypter 108 may apply a private hashed key to information, such as unecrypted transaction information 106, to generate transaction information that is encrypted by the first hash, where the resulting encrypted transaction information that may be printed on a receipt may be not readily readable coherently by a human and is therefore encrypted. The combination of public or private key and customer passcode into a hash that is applied to receipt information to create an encrypted receipt may follow a number of composition algorithms including mapping, cyphers, and the like. Once encrypted, a decryption of encrypted information may occur by using the second hash. As discussed above, the second hash corresponds to the customer passcode and a public key.

As seen in FIG. 1, the encrypter 108 may convert the unencrypted transaction information 106 using both the first key 110 and the customer passcode 112. In an example, the first key 110 may be a private key of a cryptographically asymmetric key pair and the customer passcode may be a customer specific alphanumeric code. The asymmetric key pair is asymmetric in that one key is different than the other key, rather than one key being commonly public and the other private. Indeed, both keys may be private for asymmetric encryption or authentication. The customer passcode 112 may be a pin number entered by a customer, a sequence stored in a chip card, a sequence digitally stored in a user account, or an information sequence associated with the identity of the user. Using the both the first key 110 and the customer passcode 112 the encrypter converts the unencrypted transaction information 106 into an encrypted receipt 114 through methods discussed above. Once the encrypted receipt transmitter 116 is generated, the encrypted receipt 114 may be transmitted.

The encrypted receipt 114 may include encrypted transaction information 118 such as encrypted information about items purchased, the prices of the items, the location of the purchase, the time of the purchase, and other transaction information. The encrypted transaction information 118 may be stored digitally or presented in a physical form through the use of a visible symbol such as the encrypted transaction information symbol 120. The encrypted transaction information symbol 120 may be generated by transforming the encrypted transaction information into a visible shape or pattern or picture based on a symbol generation tool. For example, a barcode generator may be used to transform information into a visible format such as a barcode following the PDF417 barcode standard, a QR code, or other visible symbol encoding format. This encrypted receipt 114 may be printed onto physical paper or sent digitally. The encrypted receipt transmitter 116 may transmit the encrypted receipt 114 to different locations based on if the encrypted receipt 114 will be printed as a physical receipt copy or held as a digital document.

While the receipt may be encrypted, even if lost and picked up by a stranger or glanced at casually, the transaction information appears as gibberish because the transaction information has been encrypted. The encrypted receipt may appear as a non-plain text symbol such as a barcode. In either case, the transaction information may be kept private until decrypted.

Whether digital or physical, the encrypted receipt 114 includes the transaction information in an encrypted form. An encrypted receipt 114 may be private until decrypted using a decryption device 122. The encrypted receipt 114 may be read by a symbol reader 124 such as a barcode scanner within the decryption device 122. While the symbol reader 124 may read a symbol, the data read may still be encrypted and not yet in a coherent plain text form. The information gathered from the symbol reader 124 may be passed to a decrypter 126 which may mirror the role of the encrypter 108 as the decrypter 126 may take encrypted information and decrypt it using the customer passcode and the second key 128. As discussed above, the first key 110 may be a private key and the second key 128 may be a public key of the public/private key pair generated using asymmetric cryptographic techniques. Additional functions and variations of public/private key assignment are discussed below. As discussed above, the customer passcode may be hashed, mapped, composited, or combined with the second key, so that whether public or private, the resulting hash of the key and the customer passcode may allow encryption and corresponding decryption upon user discretion. Once decrypted the transaction information may be in a plain text form. The use of the customer passcode 112 in the encryption and decryption process ensures that the customer may reserve the right to access their transaction information if encrypted using the customer passcode 112. The use of private key by a vendor while releasing a public key may not aid in encryption as third parties may easily gain access to a public key for decrypting the encrypted information. Decrypting encrypted information with a public key does however authenticate the origin of the transaction information as the public key only decrypts information that was encrypted with the private key. As the private key is private, the vendor or holder of the private key can be verified as the authentic provider of the transaction or transaction information. The public and private nature can be switched such that the vendor encrypts information with a public key and provides a private key only to authorized decrypting sources such as the online applications or websites belonging to the vendor. This method would provide encryption but would not ensure authentic origin of transaction because the encrypting key is public.

These tradeoffs can be overcome by using several layers of encryption such as using two key pairs where one public key and one private key are both used in an encryption and the counterparts to those keys are used in decryption. In an example, both keys in a key pair may be private. In an example, a private key used in encryption may be composited with a customer passcode, which is kept a secret by the customer, such that it becomes a hash for use in encryption. As discussed above, the use of a hash or composition method blends a public key with a private customer passcode and thus becomes a key that may only be generated with knowledge of the customer passcode, and thus is not generally available to the public. While the present disclosure discusses several methods of encryption, any combination of a public key, private key, and customer passcode is herein included.

Further, as discussed above, at least two functions can be enabled through use of keys and customer passcodes including first, encryption of the transaction information on a receipt during transit and second, the use of keys can authenticate the source of origin for a transaction, such as a specific vendor. As an example of the receipt proof or origin system, consider the utility of receipts as proof of purchase during return of an item after sale. Using a public/private key pair authentication system serves as proof of the source of goods as only the vendor has the private key. If a vendor encrypts transaction information using a private key, that key may be presumably private in the sense that it is not shared with another vendor. With public-private key pairs, a public key may be the sole key that can decrypt information encrypted by its corresponding private key. Accordingly, a vendor may be authenticated as the source of goods if the vendor's public key decrypts information, or a receipt, that was first encrypted by the specific vendor's private key. In this way, an encrypted receipt may authenticate a receipt as issued by a specific vendor. Using encryption and decryption as a source verifying authentication aids in facilitating and authorizing returns in a way that provides a failsafe for potentially misplaced, incorrectly entered, or difficult to access vendor records.

While the private key may be privately held as a secret by a particular vendor or service provider, the public key may be stored openly online for authentication purposes. The customer passcode may be secretly held by the customer, used for encryption, or stored in a credit card storage system such as a customer magnetic strip or chip. The public key may be stored in an online application provided by a vendor, payment provider, or also stored in a credit card magnetic strip or chip. As used herein, a payment provider may refer to a company that processes payments for a credit card or a company that issues and extends credit to purchasers. A key, such as a public or private key may be stored in payment provider's servers and rendered by looking up a card number or customer name in a key storage system.

A vendor or payment provider may make the public key available through an application such as an “app” or a website. A vendor may drive customers to use a key storing application as use of the application may be a prerequisite to ordering, decrypting, and viewing transaction information encrypted with the other paired key, provided by the vendor or payment provider, respectively. As further discussed above, application of keys and passcodes may occur several times and through several iterations and thus many tokens such as keys, passcodes, and passwords may be used in succession to encrypt the same transaction information. When several different parties each supply their own encryption token in an public/private key pair circumstance, each party may withhold access to the other key needed to decrypt the information unless a user follows prescribed steps in order to be given the decrypting key. As used herein, the vendor key may refer to a key provided by the vendor and may be public, private, or combined with a customer passcode as a hashed key. The vendor may be a particular store issuing a key at the time of the transaction. The vendor may be a payment processor or a credit issuing company. The vendor may be a particular location of a store.

As discussed above, the customer passcode 112 may encrypt the transaction information for the customer. In an example, the transaction information cache 104 may store a copy of the encrypted receipt 114. The purpose of this would be to store a copy incase a customer lost the encrypted receipt 114. One benefit of storing this copy after being encrypted using the customer passcode 112 may be that the customer's data remains private unless the customer again provides their passcode. This enhances customer privacy from any party that may wish to treat a vendor transaction storage location as a trove of personal information worth attacking or accessing to gain access to personal information. Even the vendor themselves would not be able to decrypt the transaction information of the customer without access to the customer passcode 112 and as such there may be a preservation of customer data with an accompanying assurance of customer privacy in many circumstances. The vendor storage of encrypted transaction information may assist in a practical way such as a misplaced receipt by a customer attempting to make a return.

While the encrypter 108 may adhere to a number of cryptographic systems, this disclosure largely includes examples of using an asymmetric cryptographic system. Other cryptographic systems are contemplated as well as hybrids with an asymmetric cryptographic systems, and as such, reference to the asymmetric use of public and private key pairs includes these hybrid systems that follow similar principles. For example, as encryption using asymmetric key algorithms can be computationally intensive and slower than symmetric cryptographic systems, the encrypter 108 may use asymmetric encryption for an initial encoding of credentials such as keys, but if combined with another of other tokens from various vendors, these generated keys from multiple sources may be combined into a single secret key. In an example, a first vendor may generate a first public key and a first private key while a second vendor may generate a second public key and a second private key. If each vendor provides the other with their public key while keeping their private key a secret, they may each generate the same single secret key for use in encryption. This single secret key may allow symmetric encryption which reduces the computational load while still providing encryption for both vendors. As used herein, references to asymmetric cryptographic systems include these types of hybrid systems that may enable multiple vendors to generate symmetric encryption tools for encrypting transaction information.

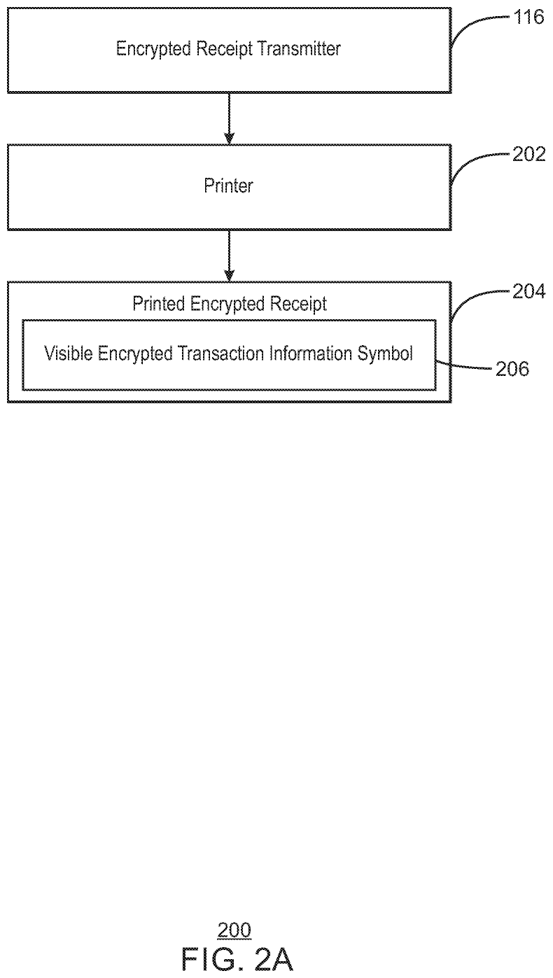

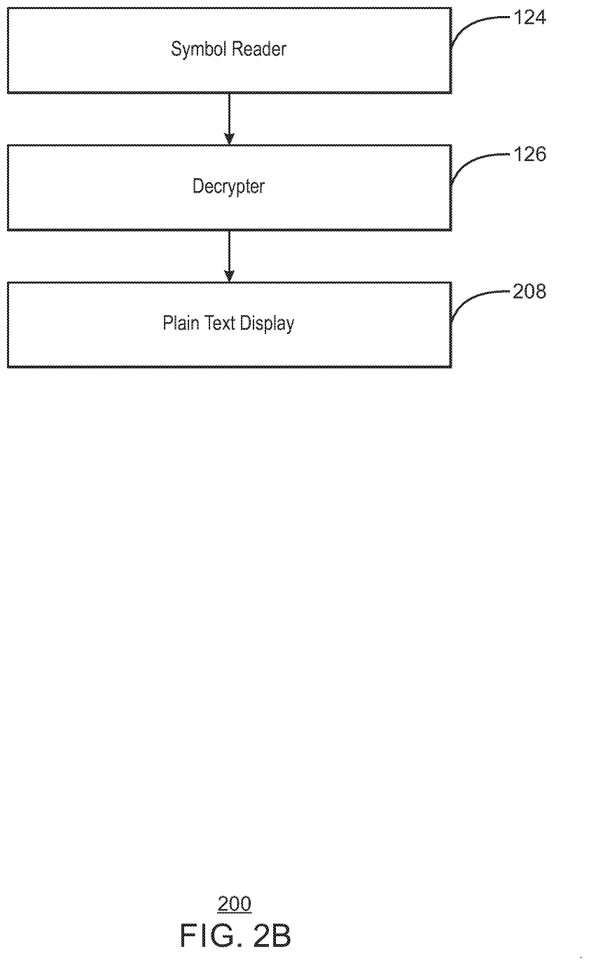

FIG. 2A is a schematic diagram 200 showing an encrypted receipt being printed. Like numbered items are as described in FIG. 1. As discussed above, the receipts may be physical receipts that are printed out at a storefront and handed to a customer. To generate encrypted receipts in these circumstances, the encryption actions can be placed between a point of service such as a cash register, and a printer 202. This placement may be as a shim application or shim hardware. As used herein, a shim or shim hardware intercepts information from previously installed system, modifies the information, and then passes along the modified information for further use. As discussed with respect to FIG. 1, an encrypter 108 may encrypt the transaction information and then provide the encrypted information to the encrypted receipt transmitter which passes the encrypted receipt to the printer 202. The printer 202 may be a receipt printer using paper and paper like substance, inks, lasers, heat and heat sensitive paper, or other means of generating a physical receipt.

The printer 202 may generate a printed encrypted receipt 204 which includes a visible encrypted transaction information symbol 206. As discussed above, the symbol may be a barcode or other glyph that includes the encrypted transaction information. At least two privacy features are present when a receipt may be encrypted and printed as a symbol. First, the transaction data can be encrypted base on a vendor's private key and a passcode provided by the customer. Second, the encrypted data can be printed to a symbol such as a PDF417 standard barcode or other symbol. The encrypted information already hides the obscures the information while the printing of a symbol further hides the information while making the encrypted information easier to capture using an electronic sensor such as the symbol reader 124. In an example, the symbol reader may be a barcode reader or a camera, such as the camera in the smartphone of a customer.

FIG. 2B is a schematic diagram 200 showing an encrypted receipt being decrypted. Like numbered items are as described in FIG. 1. After the symbol is read by the symbol reader 124 the captured data from the symbol reader 124 may then be decrypted by the decrypter 126. Once decrypted this data may be displayed as plain text in a plain text display 208. An example of a plain text display could be a display of a computer device.

With the printed encrypted receipt 204, the user may be limited in decryption methods based on the key pairs used in encryption. For example, some encryption methods may limit the ability to decrypt the receipt to a method where the vendor provides the decrypting key. For example, a vendor may only produce a matching key to a key pair in person at a point of sale, or online only through a vendor provided website or application. The customer can later decrypt the receipt using the store's app to authenticate the origin of the transaction, or if the vendor provides a public key then a third party application can authenticate with the vendor's public key. As discussed above, transaction information that is encrypted with a customer passcode may be locked until the customer again provides the passcode. Specifically, while the public and private keys may, by themselves be used for authentication, the keys and customer passcode can be combined to provide both functions. For example, when a private key and a customer passcode are hashed together before being used to encrypt and sign a receipt, then the public key by itself would not decrypt or authenticate the transaction information as decryption and authentication would require both the public key and the customer to again enter provide their passcode. The public key and customer passcode once hashed together using a complimentary hashing algorithm would generate a decrypting hash that could be used to both decrypt and authenticate the transaction information. Applying these concepts, if the receipt were stolen with the item and attempted to be returned, the return would be unsuccessful without the customer passcode as the receipt could not be decrypted without it even at the vendor location.

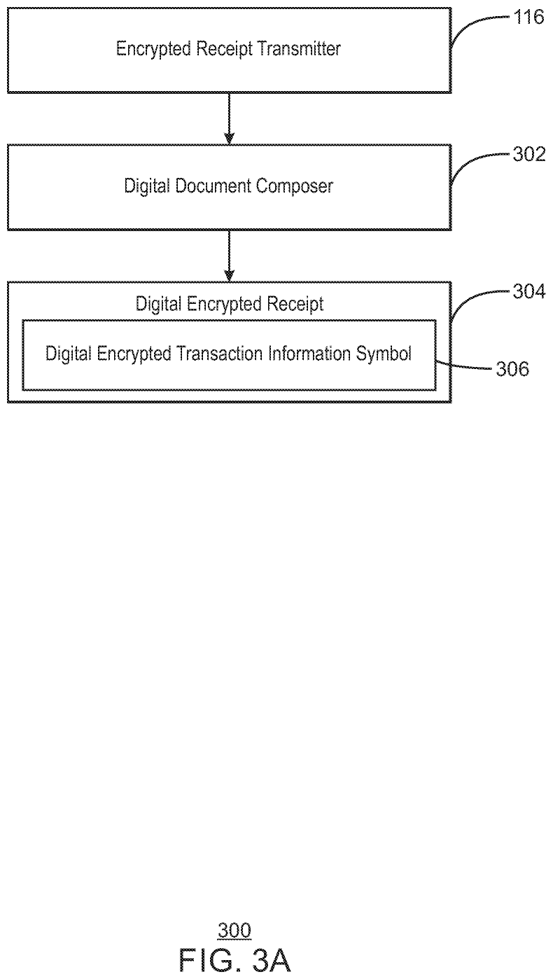

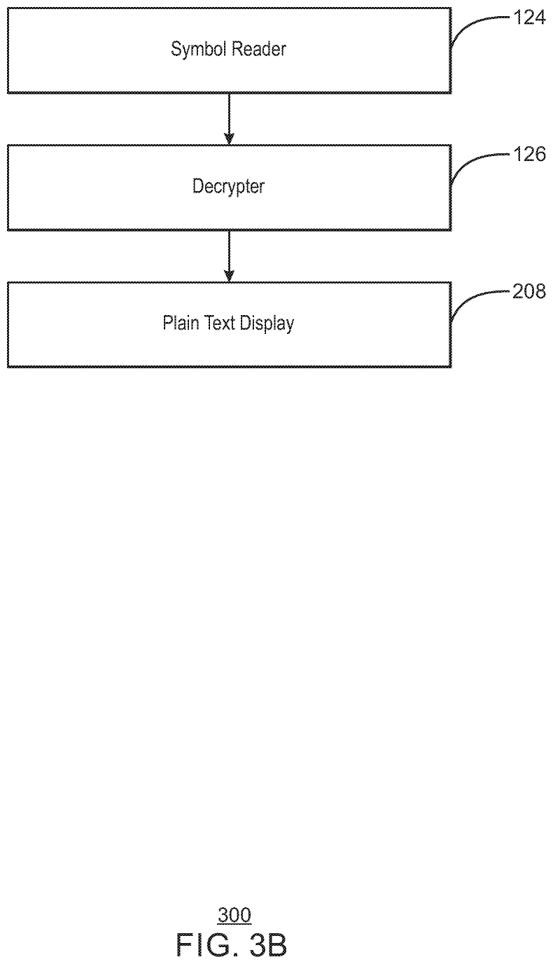

FIG. 3A is a schematic diagram 300 showing an encrypted receipt being digitally composed. Like numbered items are as described with respect to FIGS. 1 and 2.

The encrypted receipt may be transmitted digitally to a user through email or through storage in a customer associate account stored and accessible online. As digital receipts may not need to be scanned or ‘read in’ using the same sensors as a physical receipt, the encryption may take a variety of forms. For example, the encrypted receipt transmitter 116 may transmit encrypted transaction information to a digital document composer 302 such as a PDF exporter or a text processing software or email generation tool.

The digital document composer 302 generates the digital encrypted receipt 304 which may include a digital encrypted transaction information symbol 306. Due to the digital nature of the digital encrypted receipt 304 the digital encrypted transaction information symbol 306 may take forms other than those possible for a physical. For example, the digital encrypted transaction information symbol 306 may not be visible or may be stored as metadata in a file. The digital encrypted transaction information symbol 306 may still be generated as a visible symbol that may be read by a symbol reader 124.

FIG. 3A is a schematic diagram 300 showing an encrypted receipt being digitally composed and decrypted. Like numbered items are as described with respect to FIGS. 1 and 2. With the digital encrypted receipt 304 the use of a symbol reader 124 may be removed if the symbol is not a visible symbol to be read and where the encrypted information may decrypted without detection or capture by a symbol reader 124 such as a sensor. Once decrypted by the decrypter 126, the transaction information may be displayed by the plain text display 208.

As discussed above, a payment provider such as a credit issuing company or payment processing company may implement these techniques as part of their offering to their customers. The digital document composer 302 in these cases may compose a digital document or other collection of data to an application or server system managed by the payment processing company where the customer could log-in in order to access this transaction information. When a payment provider provides its own payment provider password, a separate vendor such as a store may still do a spate encryption of the receipt. As discussed above, the inclusion of a separate payment provider password may enforce a system where the customer may not be able to decrypt their transaction information without obtaining a matched payment provider password if these first and second passwords are generated using asymmetric cryptographic key pair generation methods.

Practically, the first payment provider password may be provided by the payment provider as a private encryption key that may be embedded on the chip card provided by the payment processor. The second payment provider password may be provided by the payment provider as a public encryption key that may be provided to a user upon access to the encrypted transaction information on a website of the payment provider.

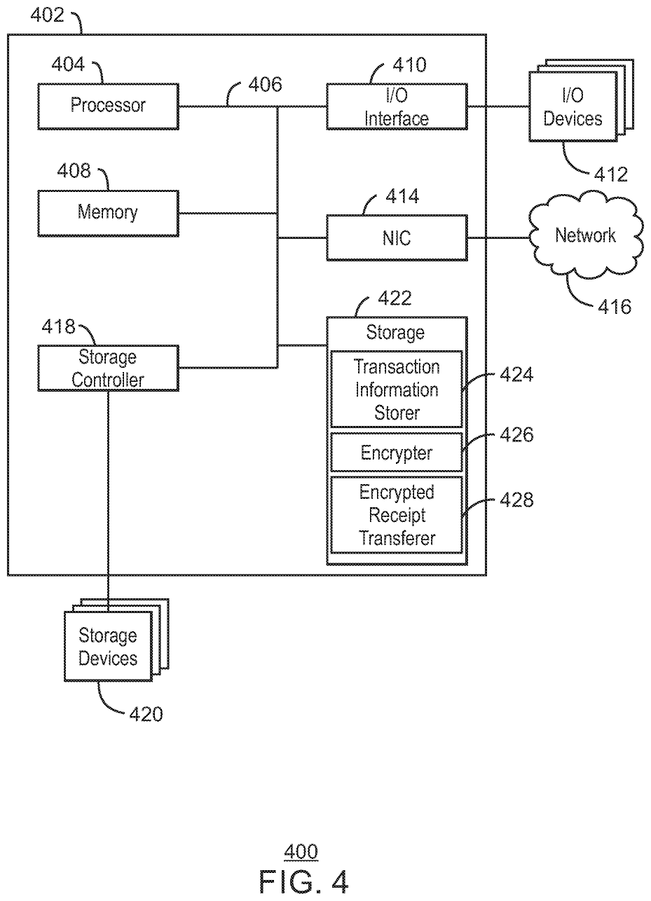

FIG. 4 is a block diagram of an example system 400 for encrypting transaction receipts. The system for encrypting transaction receipts can be a printer, a digital document generator, a shim between other hardware and software systems, or other computing device, including a print server, a desktop computer, a business server, and the like. The system 400 for encrypting transaction receipts includes a computing device 402 which includes at least one processor 404. The processor 404 can be a single core processor, a multicore processor, a processor cluster, and the like. The processor 404 can be coupled to other units through a bus 406. The bus 406 can include peripheral component interconnect (PCI) or peripheral component interconnect express (PCIe) interconnects, Peripheral Component Interconnect eXtended (PCIx), or any number of other suitable technologies for transmitting information.

The computing device 402 can be linked through the bus 406 to a memory 408. The system memory 408 can include random access memory (RAM), including volatile memory such as static random-access memory (SRAM) and dynamic random-access memory (DRAM). The system memory 408 can include directly addressable non-volatile memory, such as resistive random-access memory (RRAM), phase-change memory (PCRAM), Memristor, Magnetoresistive random-access memory, (MRAM), Spin-transfer torque Random Access Memory (STTRAM), and any other suitable memory that can be used to provide computers with persistent memory. In an example, a memory can be used to implement persistent memory if it can be directly addressed by the processor at a byte or word granularity and has non-volatile properties.

The processor 404 may be coupled through the bus 406 to an input output (I/O) interface 410. The I/O interface 410 may be coupled to any suitable type of I/O devices 412, including input devices, such as a mouse, touch screen, keyboard, display, and the like. The I/O devices 412 may be output devices such as a printhead, printer dies, indexing motors, a printer controller, and the like.

The computing device 402 can include a network interface controller (NIC) 414, for connecting the computing device 402 to a network 416. In some examples, the network 416 can be an enterprise server network, a storage area network (SAN), a local area network (LAN), a wide-area network (WAN), or the Internet, for example. The processor 404 can be coupled to a storage controller 418, which may be coupled to one or more storage devices 420, such as a storage disk, a solid state drive, an array of storage disks, or a network attached storage appliance, among others.

The computing device 402 can include a non-transitory, computer-readable storage media, such as a storage 422 for the long-term storage of data, including the operating system programs and user file data. The storage 422 can include local storage in a hard disk or other non-volatile storage elements. While generally system information may be stored on the storage 422, in this computing device 402, the program data can be stored in the memory 408. The storage 422 may store instructions that may be executed by the processor 404 to perform a task.

The storage 422 can include a transaction information storer 424 to cache unencrypted transaction information from a vendor. The transaction information storer 424 can cache a copy of the encrypted receipt after encryption which may facilitate returns. Further, as the transaction information may be stored in an encrypted state that may include encryption with a customer passcode, the customer transaction information may be kept private even when stored on a vendor system or other non-customer system.

The storage 422 can include an encrypter 426 that converts the transaction information into an encrypted receipt based on a first hash of a first vendor key of an asymmetric key pair and a customer passcode, wherein the encrypted receipt decodes to plain text of the unencrypted transaction information with a second hash of a second vendor key of the asymmetric key pair and the customer passcode. The encrypted receipt includes a visible symbol including the encrypted information. The visible symbol can be a barcode, a QR code, or other standardized visual encoding system such as PDF417 standard barcode or other standards. Encryption can be through asymmetric cryptography and if this may be implemented, the first vendor key may be a private key and the second vendor key may be a public key.

The storage 422 can include an encrypted receipt transmitter 428 to transfer the encrypted receipt. Depending on the nature of the receipt transmitter 428, the transfer by the encrypted receipt transmitter 428 is to a receipt printer. In other cases, the transfer by the encrypted receipt transmitter can be a transfer to a digital document composer in order for the encrypted receipt to be included in a digital file. If digitally transferred, the encrypted receipt may or may not be visible as the same encryption could be invisible or hidden from a user while still seen and later decoded by a digital document reader.

The encryption can be stacked and encrypted more than once using various keys, passcodes, and passwords depending on the particular use sought. The encrypter can convert the encrypted receipt into a payment processor protected receipt based on a first payment processor password of a pair of payment processor passwords, wherein the payment processor protected receipt unlocks to an encrypted receipt with a second payment processor password. Vendors may wish to link the decryption of transaction information to a customer using their particular application or “app” and to that end may allow decoding through their provided software. In this example, the second payment processor password referenced above can be accessed with a payment processor application.

Codes can be provided in a number of forms and formats. For example, the first vendor key can be a private key embedded on a chip card used for a payment in a transaction that generates the transaction information. When a chip card may be used along with asymmetric cryptography the private key may be generated by a payment provider of the chip card, and the second vendor key can be a public key generated by the payment provider of the chip card. Further, the second vendor key can be stored on the chip card used for the payment in the transaction that generates the transaction information.

It is to be understood that the block diagram of FIG. 4 is not intended to indicate that the computing device 402 is to include all of the components shown in FIG. 4. Rather, the computing device 402 can include fewer or additional components not illustrated in FIG. 4.

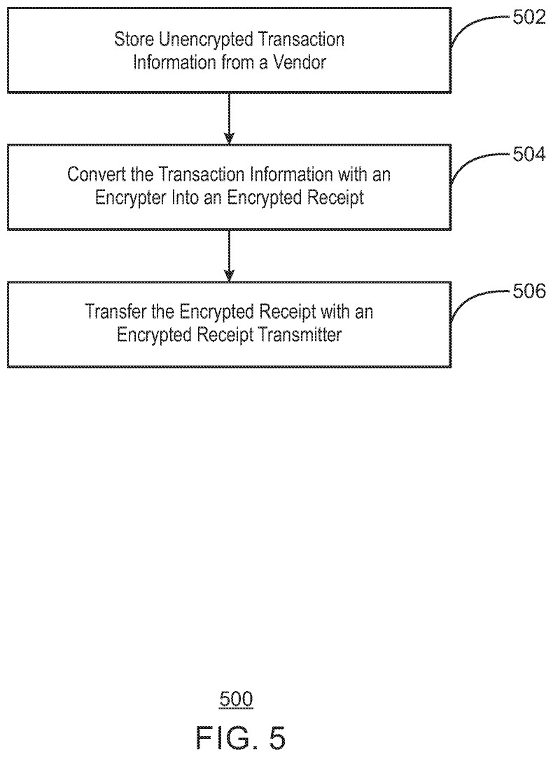

FIG. 5 is a flowchart of an example method for encrypting transaction receipts. At block 502, an unencrypted transaction information from a vendor is stored. For example, the transaction information may be stored in a transaction information cache stores. The transaction information cache can store a copy of the encrypted receipt after encryption which may facilitate returns. As discussed above, the transaction information can be stored in an encrypted state that may include encryption with a customer passcode and the customer transaction information may be kept private even when stored on a vendor system or other non-customer system.

At block 504, transaction information is converted into an encrypted receipt based on a first hash of a first vendor key of an asymmetric key pair and a customer passcode, wherein the encrypted receipt decodes to plain text of the unencrypted transaction information with a second hash of a second vendor key of the asymmetric key pair and the customer passcode. In an example, the conversion information is done by an encrypter. After converting, the encrypted receipt includes a visible symbol including the encrypted information. The visible symbol can be a barcode, a QR code, or other standardized visual encoding system such as PDF417 standard barcode or other standards. Encryption can be through asymmetric cryptography and if this can be implemented, the first vendor key can be a private key and the second vendor key can be a public key.

At block 506, the encrypted receipt is transferred with an encrypted receipt transmitter. For circumstances where a physical receipt can be appropriate, the transfer by the encrypted receipt transmitter is to a receipt printer. For circumstances where a digital receipt is appropriate, the transfer by the encrypted receipt transmitter can be to a digital document composer in order for the encrypted receipt to be included in a digital file. For digital receipts, the encrypted receipt symbol may or may not be visible because the encryption could be invisible from a user and stored instead in computer code written into the digital data of the document for decoding by a digital document reader.

The various types and sources of encryption can be stacked and can result in receipts that are encrypted more than once using various keys, passcodes, and passwords depending on the particular use sought. The encrypter can convert the encrypted receipt into a payment processor protected receipt based on a first payment processor password of a pair of payment processor passwords, wherein the payment processor protected receipt unlocks to an encrypted receipt with a second payment processor password. Vendors may wish to link the decryption of transaction information to a customer using their particular application or “app” and to that end may allow decoding through their provided software. In this example, the second payment processor password referenced above can be accessed with a payment processor application.

It is to be understood that the block diagram of FIG. 5 is not intended to indicate that the method 500 is to include all of the actions shown in FIG. 5. Rather, the method 500 can include fewer or additional components not illustrated in FIG. 5.

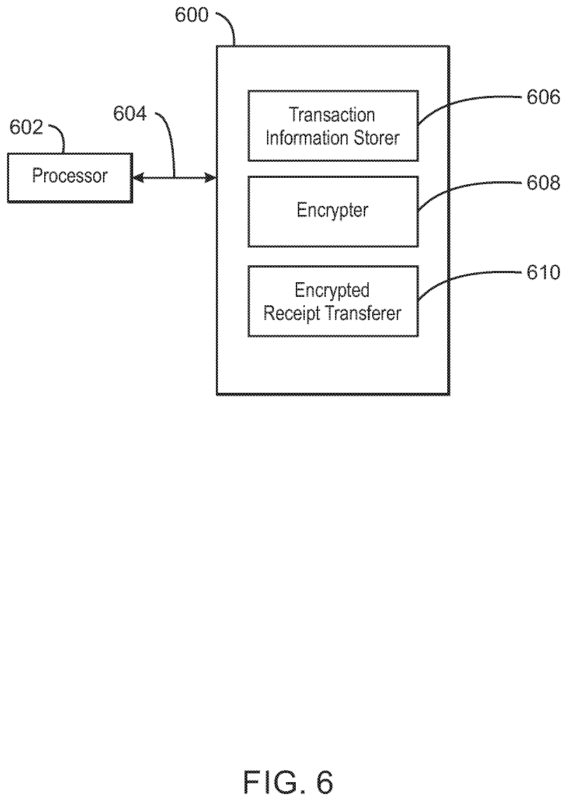

FIG. 6 is a block diagram of an example non-transitory, computer-readable medium including instructions to direct a processor to encrypt transaction receipts. The computer readable medium may include the storage 422 or the memory 408 of FIG. 4, an application specific integrated circuit, and other suitable formats readable by the computing device. The computer readable medium 600 can include the processor 602 to execute instructions received from the computer-readable medium 600. Instructions can be stored in the computer-readable medium 600. These instructions can direct the processor 602 to generate encrypted receipts including transaction information. Instructions can be communicated over a bus 604 as electrical signals, light signals, or any other suitable means of communication for transmission of data in a similar computing environment.

The computer-readable medium 600 includes a transaction information storer 606 to cache unencrypted transaction information from a vendor. The transaction information storer 606 can cache a copy of the encrypted receipt after encryption which may facilitate returns. Further, as the transaction information can be stored in an encrypted state that may include encryption with a customer passcode, the customer transaction information may be kept private even when stored on a vendor system or other non-customer system.

The computer-readable medium 600 includes an encrypter 608 that converts the transaction information into an encrypted receipt based on a first hash of a first vendor key of an asymmetric key pair and a customer passcode, wherein the encrypted receipt decodes to plain text of the unencrypted transaction information with a second hash of a second vendor key of the asymmetric key pair and the customer passcode. The encrypted receipt includes a visible symbol including the encrypted information. The visible symbol can be a barcode, a QR code, or other standardized visual encoding system such as PDF417 standard barcode or other standards. Encryption can be through asymmetric cryptography and if this is implemented, the first vendor key can be a private key and the second vendor key can be a public key.

The computer-readable medium 600 includes an encrypted receipt transferer 610 to transfer the encrypted receipt. When a vendor installs the computer-readable medium into a system for generating physical receipts, the transfer by the encrypted receipt transmitter is to a receipt printer. When a vendor installs the computer-readable medium into a system for generating digital receipts, the transfer by the encrypted receipt transmitter can be a transfer to a digital document composer in order for the encrypted receipt to be included in a digital file. If digitally transferred, the encrypted receipt may or may not be visible as the same encryption could be invisible or hidden from a user while still seen and later decoded by a digital document reader.

The encryption can be stacked and encrypted more than once using various keys, passcodes, and passwords depending on the particular use sought. The encrypter 608 can convert the encrypted receipt into a payment processor protected receipt based on a first payment processor password of a pair of payment processor passwords, wherein the payment processor protected receipt unlocks to an encrypted receipt with a second payment processor password. Vendors may wish to link the decryption of transaction information to a customer using their particular application or “app” and to that end may allow decoding through their provided software. In this example, the second payment processor password referenced above can be accessed with a payment processor application.

Codes can be provided in a number of forms and formats. For example, the first vendor key can be a private key embedded on a chip card used for a payment in a transaction that generates the transaction information. When a chip card can be used along with asymmetric cryptography the private key can be generated by a payment provider of the chip card, and the second vendor key can be a public key generated by the payment provider of the chip card. Further, the second vendor key can be stored on the chip card used for the payment in the transaction that generates the transaction information.

It is to be understood that the block diagram of FIG. 6 is not intended to indicate that the computer-readable medium 600 is to include all of the components shown in FIG. 6. Rather, the computer-readable medium 600 can include fewer or additional components not illustrated in FIG. 6.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A device for encrypted transaction receipts comprising:
a transaction information cache to store unencrypted transaction information from a vendor;
an encrypter that converts the transaction information into an encrypted receipt based on a first hash of a first vendor key of an asymmetric key pair and a customer passcode, wherein the encrypted receipt decodes to plain text of the unencrypted transaction information with a second hash of a second vendor key of the asymmetric key pair and the customer passcode; and
an encrypted receipt transmitter to transfer the encrypted receipt.

2. The device of claim 1, wherein:
the encrypted receipt comprises a visible symbol comprising the encrypted information; and
the transfer by the encrypted receipt transmitter is to a receipt printer.

3. The device of claim 2, wherein the visible symbol is a barcode.

4. The device of claim 1, wherein the transfer by the encrypted receipt transmitter is to a digital document composer.

5. The device of claim 1, wherein the first vendor key is a private key and the second vendor key is a public key.

6. The device of claim 1, wherein the transaction information cache stores a copy of the encrypted receipt.

7. The device of claim 1, wherein the encrypter is to convert the encrypted receipt into a payment processor protected receipt based on a first payment processor password of a pair of payment processor passwords, wherein the payment processor protected receipt unlocks to an encrypted receipt with a second payment processor password.

8. The device of claim 7, wherein the second payment processor password is accessed with a payment processor application.

9. The device of claim 1, wherein:
the first vendor key is a private key embedded on a chip card used for a payment in a transaction that generates the transaction information;
the private key is generated by a payment provider of the chip card; and
the second vendor key is a public key generated by the payment provider of the chip card.

10. The device of claim 9, wherein the second vendor key is stored on the chip card used for the payment in the transaction that generates the transaction information.

11. A method for encrypted transaction receipts comprising:
storing unencrypted transaction information from a vendor in a transaction information cache;
converting the transaction information with an encrypter into an encrypted receipt based on a first hash of a first vendor key of an asymmetric key pair and a customer passcode, wherein the encrypted receipt decodes to plain text of the unencrypted transaction information with a second hash of a second vendor key of the asymmetric key pair and the customer passcode; and
transferring the encrypted receipt with an encrypted receipt transmitter.

12. The method of claim 11, wherein:
the encrypted receipt comprises a visible symbol comprising encrypted transaction information; and
the transfer by the encrypted receipt transmitter is to a receipt printer.

13. The method of claim 12, wherein the visible symbol is a barcode.

14. A non-transitory, computer-readable medium comprising instructions that, in response to an execution by a processor:
store unencrypted transaction information from a vendor in a transaction information cache;
convert the transaction information with an encrypter into an encrypted receipt based on a first hash of a first vendor key of an asymmetric key pair and a customer passcode, wherein the encrypted receipt decodes to plain text of the unencrypted transaction information with a second hash of a second vendor key of the asymmetric key pair and the customer passcode; and
transfer the encrypted receipt with an encrypted receipt transmitter.

15. The non-transitory, computer-readable medium of claim 14 wherein:
the encrypted receipt comprises a visible symbol comprising encrypted transaction information; and
the transfer by the encrypted receipt transmitter is to a receipt printer.
